(19) United States
(12) Patent Application Publication
(10) Pub. No.: US 2026/0066725 A1
(43) Pub. Date: Mar. 5, 2026

(54) LOW PROFILE ROTOR FOR ROTATABLE MACHINING PLATFORMS

(71) Applicant: SKF CANADA LIMITED, Scarborough (CA)

(72) Inventors: Daren Paul TREMAINE, Silverton (CA); Evan MCNEIL, Calgary (CA); Osama GHAFOOR, Calgary (CA); Timothy Andrew HARRIS, Calgary (CA)

(21) Appl. No.: 18/824,085

(22) Filed: Sep. 4, 2024

(51) Int. Cl. H02K 1/28; H02K 1/02; H02K 1/16; H02K 7/04

(52) U.S. Cl. CPC H02K 1/28; H02K 1/02; H02K 1/16; H02K 7/04

(57) ABSTRACT

A rotor assembly for angularly displacing a platform about a central axis includes a stator assembly having a central bore and including a plurality of electromagnetic coil assemblies spaced circumferentially about the central axis. An annular rotor is connectable with the platform and is disposed within the central bore of the stator assembly so as to be centered about the central axis. The rotor includes a cylindrical sidewall having an inner circumferential surface, an outer circumferential surface, upper and lower axial ends spaced apart along the central axis and a plurality of through openings extending radially between the inner and outer circumferential surfaces and spaced circumferentially about the central axis. As such, a separate one of a plurality of teeth are defined between each pair of adjacent openings and a lower annular rim portion is defined axially between the plurality of through openings and the lower end of the sidewall.

### BACKGROUND OF THE INVENTION

The present invention relates to rotors of electric machines, and more particularly to rotors used to angularly displace machining platforms in manufacturing equipment.

In certain industries, such as semiconductor manufacturing, it is often desirable to use electric motors to rotate platforms for supporting components undergoing one or more machining processes. These motors typically include a stator with a plurality of electromagnetic coil assemblies for applying magnetic torque to a central rotor, which is connected to a platform having a surface for supporting a product to be machined, such as a semiconductor wafer. When the rotor is made of a ferromagnetic material, it is generally necessary to provide a “toothed” structure of alternating ferromagnetic teeth and nonmagnetic air gaps. Such a structure enables proper magnetic flux paths to be generated within the rotor by the coil assemblies of the stator in order to exert torque on the rotor, specifically on the edges of the ferromagnetic teeth.

In certain applications, a toothed rotor structure is provided by a rotor formed generally as a gear and including a central hub and a plurality of teeth each extending radially outwardly from and spaced circumferentially about the hub. As a gear type of rotor structure requires a sufficient radial thickness in order to form both the hub and the plurality of teeth, the mass and rotational inertia of the rotor may be greater than desired. Alternatively, rotor teeth may be formed by cutting a plurality of axial slots extending from one axial end of a cylinder so that the cut cylinder has a plurality of teeth defined between the axial slots and connected to a remaining solid portion of the cylinder. Such a “crenellated” structure may have a reduced radial thickness for a given rotor outside diameter, and thus also a reduced mass, in comparison with a gear type of rotor. However, magnetic flux generated by the stator coils must pass through an air gap between the teeth, which reduces the amount of torque generated for a given electric current through the coils, and the free ends of the teeth may shear items contacting the teeth during rotation, thus creating a potentially dangerous operating condition.

### SUMMARY OF THE INVENTION

In one aspect, the present invention is a rotor assembly for angularly displacing a platform about a central vertical axis and comprising a stator assembly having a central bore and including a plurality of electromagnetic coil assemblies spaced circumferentially about the central axis. An annular rotor is connectable with platform and disposed within the central bore of the stator assembly so as to be centered about the central axis. The rotor includes a cylindrical sidewall having an inner circumferential surface, an outer circumferential surface, an upper axial end and a lower axial end spaced apart along the central axis, and a plurality of through openings extending radially between the inner and outer circumferential surfaces of the sidewall and spaced circumferentially about the central axis. As such, a separate one of a plurality of teeth are defined circumferentially between each pair of adjacent openings and a lower annular rim portion is defined axially between the plurality of through openings and the lower end of the sidewall. Each one of the plurality of electromagnetic coil assemblies exerts magnetic torque on one or more of the plurality of teeth of the rotor such that the rotor angularly displaces about the central axis. Further, electric current flowing through each one of the plurality of electromagnetic coil assemblies generates magnetic flux flowing in a circuitous path extending radially inwardly from one arm of the one electromagnetic coil assembly and into one of the plurality of teeth, then flowing in a first branch axially upwardly through the one tooth, circumferentially through a portion of the sidewall extending circumferentially between the one tooth and an adjacent one of the teeth, axially downwardly through the adjacent tooth and radially outwardly into another arm of the one electromagnetic coil assembly and simultaneously flowing in a second branch axially downwardly through the one tooth, circumferentially through the lower annular rim portion, axially upwardly through the adjacent tooth and radially outwardly into the other arm of the one electromagnetic coil assembly.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a manufacturing platform including a rotor assembly in accordance with the present invention;

FIG. 2 is top plan view of the rotor assembly;

FIG. 3 is a perspective view of the rotor assembly;

FIG. 4 is a perspective view of a rotor of the rotor assembly;

FIG. 5 is an axial cross-sectional view of the rotor;

FIG. 6 is an enlarged, broken-away view of a portion of FIG. 6; and

FIG. 7 is an enlarged, broken-away perspective view of the rotor and a core member of an electromagnetic coil assembly, showing a magnetic flux path through the rotor.

### DETAILED DESCRIPTION OF THE INVENTION

Certain terminology is used in the following description for convenience only and is not limiting. The words “lower” and “upper” designate directions in the drawings to which reference is made and the words “inner”, “inwardly” and “outer”, “outwardly” refer to directions toward and away from, respectively, a designated central axis. The terminology includes the words specifically mentioned above, derivatives thereof, and words of similar import.

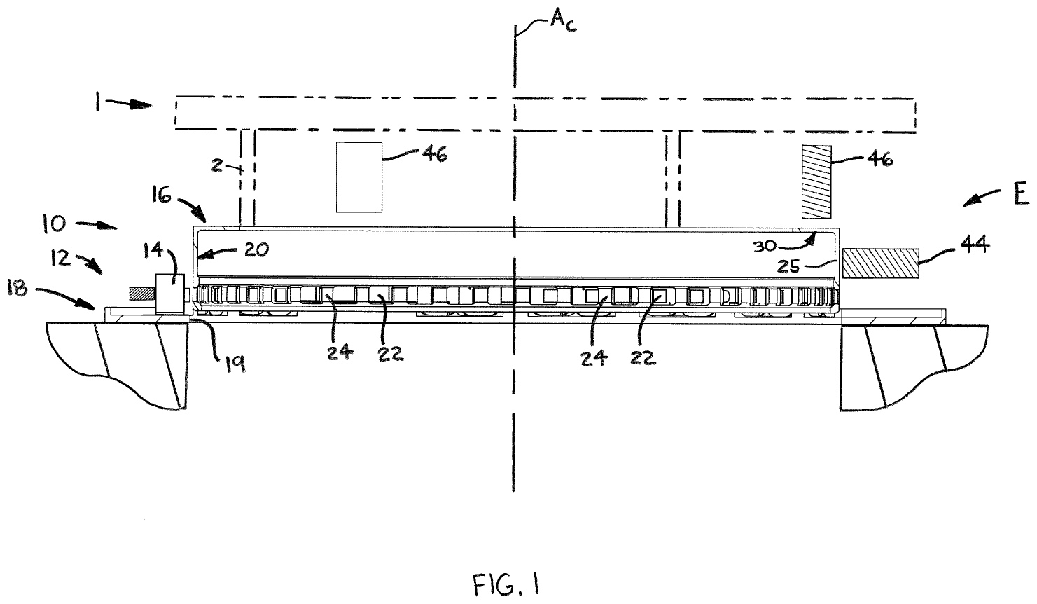

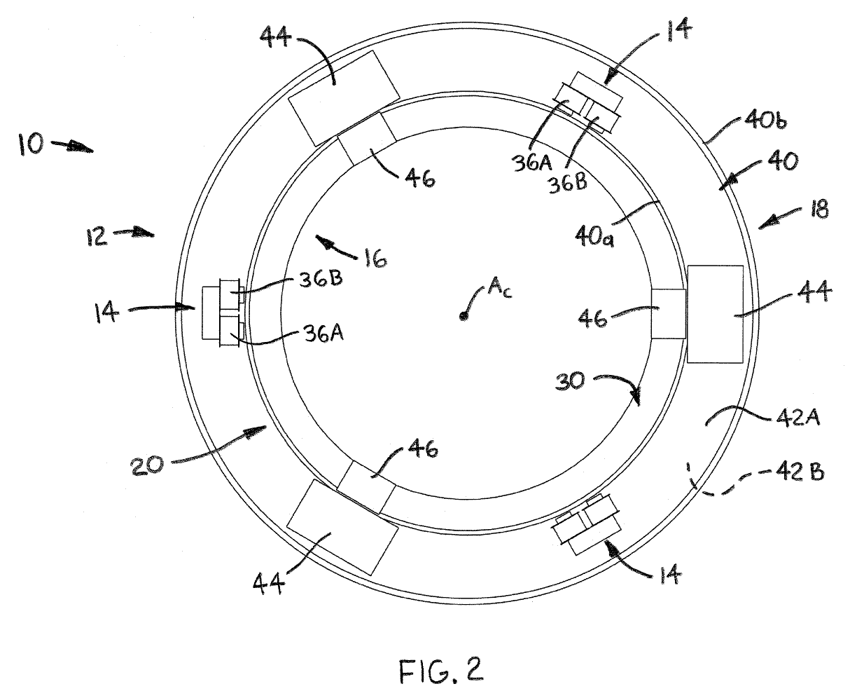

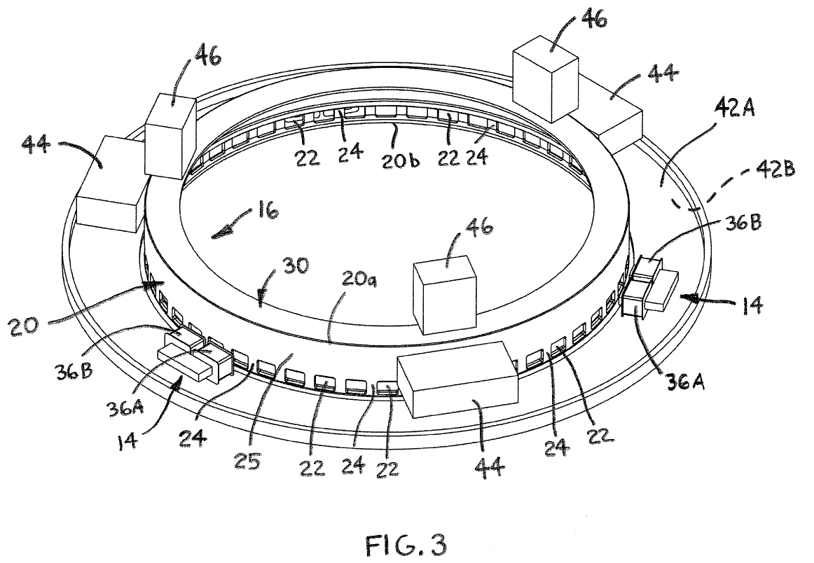

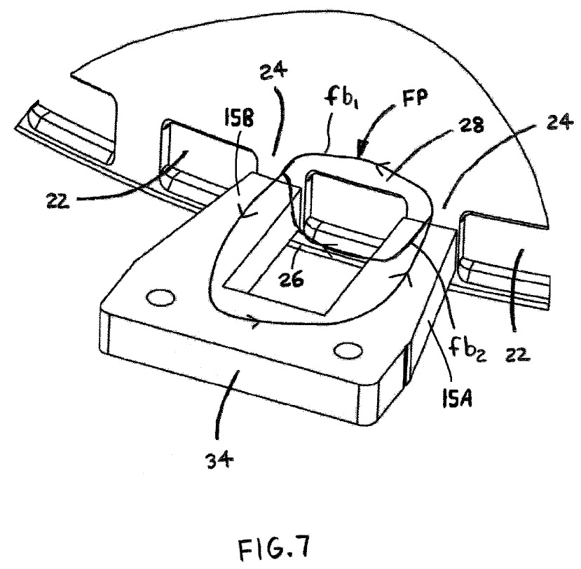

Referring now to the drawings in detail, wherein like numbers are used to indicate like elements throughout, there is shown in FIGS. 1-7 a rotor assembly 10 for angularly displacing a platform 1 (indicated by phantom lines in FIG. 1) about a central vertical axis A_{C}. The platform 1 and the rotor assembly 10 are preferably components of an item of manufacturing equipment E, most preferably a semiconductor manufacturing machine, but may be incorporated into any appropriate device requiring a rotatable platform 1. The rotor assembly 10 basically comprises a stator assembly 12 including a plurality of electromagnetic coil assemblies 14 and an annular rotor 16 connectable with the platform 1.

More specifically, the stator assembly 12 includes a housing 18 having a central bore 19, the plurality of electromagnetic coil assemblies 14 being mounted within the housing 18 so as to be spaced circumferentially about the central axis A_{C}. As shown in FIG. 7 and described in further detail below, each coil assembly 14 includes first and second arms 15A, 15B, respectively, and two coil assemblies 36A, 36B wound respectively about each arm 15A, 15B. The annular rotor 16 is disposed within the central bore 19 of the stator housing 18 so as to be centered about the central axis A_{C} and includes a cylindrical sidewall 20 and a radial flange 30. The cylindrical sidewall 20 has an inner circumferential surface 21A, an outer circumferential surface 21B, an upper axial end 20a and a lower axial end 20b spaced apart along the central axis A_{C}. A plurality of through openings 22 extends radially between the inner and outer circumferential surfaces 21A, 21B of the sidewall 20 and are spaced circumferentially about the central axis A_{C}. As such, a separate one of a plurality of teeth 24 are defined between each pair of adjacent openings 22.

Preferably, the through openings 22 are generally adjacent to the lower axial end 20b of the sidewall 20 such that a lower annular rim portion 26 is defined axially between the plurality of through openings 22 and the lower end 20b of the sidewall 20. Alternatively, the through openings 22 are generally adjacent to the sidewall upper axial end 20a and an upper annular rim portion is defined axially between the plurality of through openings 22 and the upper end 20a of the sidewall 20 (structure not shown).

Further, the radial flange 30 extends radially inwardly from the upper end 20a of the cylindrical wall 20 and is configured to connect with the platform 1, for example by means of a plurality of axially-extending couplers 2 (shown in phantom lines in FIG. 1) so as to couple the platform 1 with the rotor 16. The radial flange 30 has an outer radial end 30a integrally formed with the upper axial end 20a of the sidewall 20, an inner radial end 30b defining a central opening 32, an upper radial surface 31A and a lower radial surface 31B. Furthermore, the flange 30 provides a mass magnetically engageable by levitation actuators 46, as described below.

In operation, each one of the plurality of electromagnetic coil assemblies 14 exerts magnetic torque on one or more of the plurality of teeth 24 of the rotor 16, i.e., when electric current flows through coil assemblies 14, such that the rotor 16 angularly displaces about the central axis A_{C} to thereby angularly displace or rotate the platform 1. Referring particularly to FIG. 7, with the preferred rotor structure as described above, electric current flowing through each one of the plurality of electromagnetic coil assemblies 14 generates magnetic flux that flows in a circuitous path FP extending radially inwardly from the first arm 15A of the one electromagnetic coil assembly 14 and into one of the plurality of teeth 24, then flowing in a first branch fb₁ axially upwardly through the one tooth 24, circumferentially through a portion of the sidewall 20 extending circumferentially between the one tooth 24 and an adjacent one of the teeth 24, axially downwardly through the adjacent tooth 24 and radially outwardly into the second arm 15B of the one electromagnetic coil assembly 14. Simultaneously, the magnetic flux flowing radially inwardly from the first arm 15A of the one coil assembly 14 flows in a second branch fb₂ of the path FP axially downwardly through the one tooth 24, circumferentially through the lower annular rim portion 26, axially upwardly through the one adjacent tooth 24 and radially outwardly into the other arm 15B of the one electromagnetic coil assembly 14. Alternatively, if the rotor 16 is formed such that the through openings 22 are adjacent to the upper end 20a of the sidewall 20 and an upper annular rim portion is formed, the magnetic flux circuitous flow path FP is substantially the same, except that the first branch fb₁ flows axially downwardly through the one tooth 24 and the second branch fb₂ flows axially upwardly through the one tooth 24 (alternate path not depicted).

Thus, due to the rotor teeth 24 being formed by providing enclosed through openings 22 in the sidewall 20, a continuous magnetic flux path FP extends through two adjacent teeth 24 by means of two separate path branches fb₁, fb₂, which eliminates or at least reduces flux fringing such that the torque applied to the rotor 16 is maximized for a given electric current through the electromagnetic coil assemblies 14. Such a rotor structure may be formed with a substantially reduced radial thickness, and thus correspondingly reduced mass and rotational inertia, in comparison to a gear type of rotor, since the two flux path branches fb₁, fb₂ reduces magnetic saturation, as discussed in further detail below. Additionally, the lower annular rim portion 26 connecting the lower ends 24b of all of the teeth 24 prevents the teeth lower ends 24b from acting as a “saw” during rotation, thereby eliminating a major drawback of a crenellated rotor design. Having described the basic structure and functioning of the present rotor assembly 10 above, these and other components of the present invention are described in further detail below.

Referring to FIGS. 1-3, the housing 18 of the stator assembly 12 includes an annular baseplate 40 having an inner radial end 40a defining the central bore 19, an opposing outer radial end 40b, an upper circular support surface 42A and an opposing bottom surface 42B. The plurality of electromagnetic coil assemblies 14 are mounted on the upper surface 42A of the baseplate 40 so as to be spaced about the central bore 19. Preferably, each coil assembly 14 preferably includes a U-shaped conductive core 34 providing the first and second arms 15A, 15B, as best shown in FIG. 7, and two windings 36A, 36B each electrically connected to a source of variable current (not shown), which controls the current based on the rotor angular displacement and speed, as measured by angular sensors (not shown). As such, electric current flowing through each of the windings 36A, 36B generates a magnetic field which is engageable with the rotor 16 as described in further detail below.

Further, the stator assembly 12 also includes at least one and preferably three radial actuators 44 and at least one and preferably three levitation actuators 46. The three radial actuators 44 are mounted on the upper surface 42A of the base plate 40 so as to be spaced circumferentially apart about the central axis A_{C} and are configured to magnetically engage with the sidewall 20 of the rotor 16. Furthermore, the three levitation actuators 46 are each attached to the baseplate 40 by a separate mounting bracket assembly (not shown) and are configured to exert electromagnetic force on the radial flange 30 so as to retain a vertical position of the rotor 16 along the central axis A_{C}. Although the stator assembly 12 is preferably formed as described above, the stator assembly 12 may be constructed so as to be disposed within the rotor 16, with the coil assemblies 14 arranged about the inner perimeter of the rotor 16 and the radial actuators 44 and levitation actuators 46 being appropriately arranged (structure not shown).

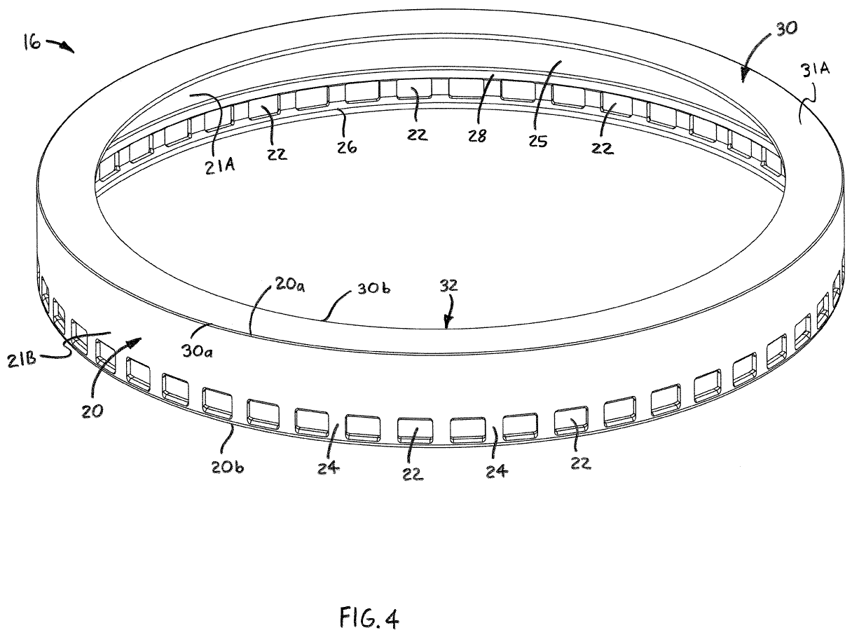

Referring now to FIGS. 4-6, the rotor 16 is preferably formed such that the plurality of through openings 22 are preferably formed generally adjacent to the lower end 20b of the sidewall 20, such that a cylindrical solid portion 25 of the sidewall 20 is defined axially between the upper end 20a of the sidewall 20 and the plurality of through openings 22. With this structure, the radial actuators 44 of the stator assembly 12 are configured to exert electromagnetic force on the cylindrical solid portion 25 so as to center the rotor 16 about the central axis A_{C}. Specifically, the three radial actuators 44 are spaced circumferentially apart by about one hundred twenty degrees (120°) and each exert an attractive or pulling force on the sidewall solid portion 25 as necessary when determined by a position controller (not depicted) so as to maintain the rotor 16 centered about the central axis A_{C}.

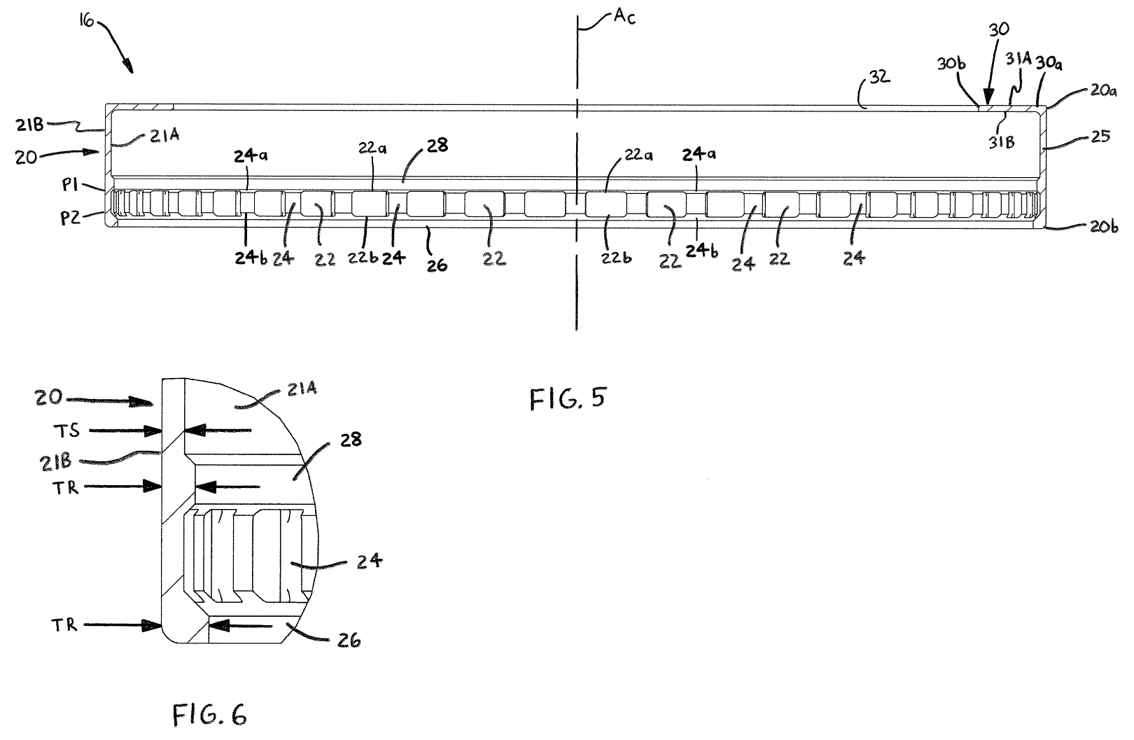

Referring particularly to FIG. 5, each through opening 22 is preferably rectangular and has an upper end 22a adjacent to the solid portion 25 and a lower end 22b adjacent to the lower annular rim portion 26. Similarly, each tooth 24 is generally rectangular and has an upper end 24a at a first axial position P1 on the sidewall 20 adjacent to the solid portion 25 and a lower end 24b at a second axial position P2 on the sidewall 20 adjacent to the lower annular rim portion 26, as indicated in FIG. 5. With this rotor structure, each one of the plurality of electromagnetic coils 14 is spaced radially outwardly from the outer circumferential surface 21B of the rotor 16 and is at least partially located axially between the first and second axial positions P1, P2 on the sidewall 20. Thereby, the coil assemblies 14 are best positioned to exert magnetic torque on the teeth 24 to angularly displace the rotor 16 about the central axis A_{C}.

Preferably, the rotor 16 further includes an upper annular rim portion 28 extending radially inwardly from the inner circumferential surface 21A of the sidewall 20 so as to be spaced axially apart from the lower annular rim portion 26 and disposed adjacent to the upper end 24a of each one of the plurality of through openings 24. Preferably, the lower annular rim portion 26 also extends radially inwardly from the rotor inner circumferential surface 21A and each rim portion 26, 28 has a radial thickness TR greater than the remainder of the sidewall 20. Specifically, the sidewall 20 of the rotor 16 has a radial thickness TS between the inner circumferential surface 21A and the outer circumferential surface 21B and the radial thickness TR of the two rim portions 26, 28 is greater than the radial thickness TS of the remainder of the sidewall 20, preferably about twice as great. As such, the rim portions 26, 28 have increased thickness TP to improve the flow of magnetic flux about the flux path FP while the reduced thickness TS of the remainder of the sidewall 20 deceases the mass and rotational inertia of the rotor 16.

Preferably, the rotor 16 is fabricated from a single piece of a ferromagnetic material, most preferably of ferromagnetic stainless steel, but may be formed of any other appropriate material such as low carbon steel, nickel, etc. Such a one-piece, stainless steel rotor 16 is particularly well suited to the semiconductor manufacturing industry due to the ease of cleaning, minimal risk of process contamination and resistance to chemical attack.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A rotor assembly for angularly displacing a platform about a central vertical axis, the rotor assembly comprising:
a stator assembly including a plurality of electromagnetic coil assemblies spaced circumferentially about the central axis; and
an annular rotor connectable with platform and centered about the central axis, the rotor including a cylindrical sidewall having an inner circumferential surface, an outer circumferential surface, an upper axial end and a lower axial end spaced apart along the central axis, and a plurality of through openings extending radially between the inner and outer circumferential surfaces of the sidewall and spaced circumferentially about the central axis such that a separate one of a plurality of teeth are defined between each pair of adjacent openings and an annular rim portion is defined axially between the plurality of through openings and one of the upper axial end of the sidewall and the lower axial end of the sidewall;
wherein each one of the plurality of electromagnetic coil assemblies exerts magnetic torque on one or more of the plurality of teeth of the rotor such that the rotor angularly displaces about the central axis.

2. The rotor assembly as recited in claim 1, wherein the stator assembly has a central bore and the annular rotor is disposed within the central bore of the stator assembly.

3. The rotor assembly as recited in claim 1, wherein electric current flowing through each one of the plurality of electromagnetic coil assemblies generates magnetic flux flowing in a circuitous path extending radially inwardly from one arm of the one electromagnetic coil assembly and into one of the plurality of teeth, then flowing in a first branch axially through the one tooth, circumferentially through a portion of the sidewall extending circumferentially between the one tooth and an adjacent one of the teeth, axially through the adjacent tooth and radially outwardly into another arm of the one electromagnetic coil assembly and simultaneously flowing in a second branch axially through the one tooth, circumferentially through the annular rim portion, axially through the adjacent tooth and radially outwardly into the other arm of the one electromagnetic coil assembly.

4. The rotor assembly as recited in claim 1, wherein:
each one of the plurality of teeth has an upper end at a first axial position on the sidewall and a lower end at a second axial position on the sidewall; and
each one of the plurality of electromagnetic coils of the stator assembly is spaced radially outwardly from the outer circumferential surface of the rotor and is at least partially located axially between the first and second axial positions on the sidewall.

5. The rotor assembly as recited in claim 1, wherein:
the sidewall of the rotor has a solid cylindrical portion located axially between the upper end of the sidewall and the plurality of through openings; and
the stator assembly further comprises at least one radial actuator configured to exert electromagnetic force on the solid cylindrical portion of the sidewall so as to center the rotor about the central axis.

6. The rotor assembly as recited in claim 1, wherein:
the rotor further includes a radial flange extending radially inwardly from the upper end of the cylindrical wall; and
the stator assembly further includes at least one levitation actuator configured to exert electromagnetic force on the radial flange so as to retain a vertical position of the rotor along the central axis.

7. The rotor assembly as recited in claim 6, wherein the radial flange of the rotor is connectable with the platform so as to couple the platform with the rotor.

8. The rotor assembly as recited in claim 1, wherein each one of the through openings has an upper end and the rotor further includes an upper annular rim portion extending axially inwardly from the inner circumferential surface of the sidewall, spaced axially apart from the lower annular rim portion and disposed adjacent to the upper end of each one of the plurality of through openings.

9. The rotor assembly as recited in claim 8, wherein the sidewall of the rotor has a radial thickness between the inner circumferential surface and the outer circumferential surface, the lower annular rim portion and the upper annular rim portion each having a radial thickness greater than the radial thickness of the sidewall.

10. The rotor assembly as recited in claim 9, wherein the radial thickness of the sidewall is less than half of a value of the radial thickness of the lower annular rim portion and of a value of the radial thickness of the upper annular rim portion.

11. The rotor assembly as recited in claim 1, wherein each one of the plurality of through openings is rectangular.

12. The rotor assembly as recited in claim 1, wherein the rotor is fabricated from a single piece of a stainless steel.

13. A rotor assembly for angularly displacing a platform about a central vertical axis, the rotor assembly comprising:
a stator assembly having a central bore and including a plurality of electromagnetic coil assemblies spaced circumferentially about the central axis; and
an annular rotor connectable with the platform, disposed within the central bore of the stator assembly so as to be centered about the central axis, the rotor including a cylindrical sidewall having an inner circumferential surface, an outer circumferential surface, an upper axial end and a lower axial end spaced apart along the central axis, and a plurality of through openings extending radially between the inner and outer circumferential surfaces of the sidewall and spaced circumferentially about the central axis such that a separate one of a plurality of teeth are defined between each pair of adjacent openings and a lower annular rim portion is defined axially between the plurality of through openings and the lower end of the sidewall;
wherein each one of the plurality of electromagnetic coil assemblies exerts magnetic torque on one or more of the plurality of teeth of the rotor such that the rotor angularly displaces about the central axis; and
wherein electric current flowing through each one of the plurality of electromagnetic coil assemblies generates magnetic flux flowing in a circuitous path extending radially inwardly from one arm of the one electromagnetic coil assembly and into one of the plurality of teeth, then flowing in a first branch axially upwardly through the one tooth, circumferentially through a portion of the sidewall extending circumferentially between the one tooth and an adjacent one of the teeth, axially downwardly through the adjacent tooth and radially outwardly into another arm of the one electromagnetic coil assembly and simultaneously flowing in a second branch axially downwardly through the one tooth, circumferentially through the lower annular rim portion, axially upwardly through the adjacent tooth and radially outwardly into the other arm of the one electromagnetic coil assembly.

14. The rotor assembly as recited in claim 13, wherein:
the sidewall of the rotor has a solid cylindrical portion located axially between the upper end of the sidewall and the plurality of through openings; and
the stator assembly further comprises at least one radial actuator configured to exert electromagnetic force on the solid cylindrical portion of the sidewall so as to center the rotor about the central axis.

15. The rotor assembly as recited in claim 13, wherein:
the rotor further includes a radial flange extending radially inwardly from the upper end of the cylindrical wall; and
the stator assembly further includes at least one levitation actuator configured to exert electromagnetic force on the radial flange so as to retain a vertical position of the rotor along the central axis.

16. The rotor assembly as recited in claim 15, wherein the radial flange of the rotor is connectable with the platform so as to couple the platform with the rotor.

17. The rotor assembly as recited in claim 13, wherein the rotor further includes an upper annular rim portion extending axially inwardly from the inner circumferential surface of the sidewall, spaced axially apart from the lower annular rim portion and disposed adjacent to the upper end of the plurality of through openings.

18. The rotor assembly as recited in claim 17, wherein the sidewall of the rotor has a radial thickness between the inner circumferential surface and the outer circumferential surface, the lower annular rim portion and the upper annular rim portion each having a radial thickness greater than the radial thickness of the sidewall.

19. The rotor assembly as recited in claim 18, wherein the radial thickness of the sidewall is less than half of a value of the radial thickness of the lower annular rim portion and of a value of the radial thickness of the upper annular rim portion.

20. The rotor assembly as recited in claim 12, wherein the rotor is fabricated from a single piece of stainless steel.
